(19) United States
(12) Patent Application Publication
(10) Pub. No.: US 2020/0349667 A1
(43) Pub. Date: Nov. 5, 2020

(54) (LOSE-LOSE)-WIN RESOLUTION OF CONFLICT

(71) Applicant: Joel Steven Goldberg, Hillsborough, NC (US)

(72) Inventor: Joel Steven Goldberg, Hillsborough, NC (US)

(21) Appl. No.: 16/924,375

(22) Filed: Jul. 9, 2020

(51) Int. Cl. G06Q 90/00

(52) U.S. Cl. CPC G06Q 90/00

(57) ABSTRACT

Until the physiology of the brain and actions from the human mind are better understood, negotiations are the primary peaceful processes to resolve conflicts. Win-win resolution of conflicts often involves creativity and may not be possible. Compromise or lose-lose is a frequent alternative to win-win. However, addition of a third party interest in dyad conflicts may change the resolution of the conflict from lose-lose to (lose-lose)-win, which is a more favorable outcome. Unfortunately game theory outcome may not accurately predict long term outcome.

### CROSS-REFERENCES TO RELATED APPLICATIONS

None

### FEDERALLY FUNDED RESEARCH

None

### BACKGROUND OF THE INVENTION

The present trajectory of human civilization is not sustainable. The history of civilization reveals that empires are built, but they never survive. Even those empires with significant technologic advantages such as the Gunpowder Empires (Ottoman, Safavid, and Mughal dynasties) eventually dissolve. President and General Dwight Eisenhower understood this concept when he stated:

Every gun that is made, every warship launched, every rocket fired signifies, in the final sense, a theft from those who hunger and are not fed, those who are cold and are not clothed. This world in arms is not spending money alone. It is spending the sweat of its laborers, the genius of its scientists, and the hopes of its children. The cost of one modern heavy bomber is this: a modern brick school in more than 30 cities. It is two electric power plants, each serving a town of 60,000 population. It is two fine, fully equipped hospitals. It is some fifty miles of concrete pavement. We pay for a single fighter with a half-million bushels of wheat. We pay for a single destroyer with new homes that could have housed more than 8,000 people.

Increasing military spending with increasing sophisticated weapons, and increasing sovereign debt, at some point, will become unsustainable. World population growth with food, energy, and health care insecurities is also unsustainable. Much work from leaders and constituents of nations needs to be done to insure human civilization is sustainable, and conflicts need to be peacefully resolved. The following are proposed solutions to these major problems impeding sustainable civilizations:

Food insecurity

It is anticipated that there will be a global food shortage if population growth is not abated by 2050, especially in Sub-Saharan Africa and Southeast Asia. Cultivation of traditional food staples such as rice, wheat, and corn require yearly planting, and animal food sources from grazing animals is energy intensive. It is not sustainable. Sources of food from the sea may also not be sustainable if fishing is not more closely regulated. Perennial ryegrass, which does not need to be planted yearly, easily adapts to many climates, and is a source of all essential amino acids for humans may be an inexpensive and important food source. [1, 2] The major impediment for human consumption of ryegrass is the cellulose content which makes it indigestible for human consumption; however, extraction (juicing), centrifugation, simple filtering, and microscopic monitoring of the extract may make it suitable as a complete food source for human sustenance.[1] The grass can be processed from hay which will require hydration, or it can be processed from the fresh cut. The advantage of the former is that hay can be stored for long periods of time, but harvesting needs to be timed according to the variability of the weather, and the hay needs to be rehydrated with a decalcification softener, such as citrate, prior to extracting.[1, 2] Using the fresh cut, the grass is washed, juiced without any additives, centrifuged, and filtered and the final extract is equally as palatable as wheat grass extract and with less cellulose.[1] Whether processing of perennial ryegrass to include harvesting, extracting, centrifugation, and filtration is economically feasible compared with a traditional grain crop such as rice, wheat, or corn remains to be seen. Presently, the Denmark National Food Institute is investigating the potential benefits of fresh grass protein for human consumption.[3]

### Energy Insecurity

Much has been accomplished in the last fifty years to increase the efficiency of renewable, sustainable, environmentally friendly energy in the form of wind, solar, and hydro power. Previously it was shown that a simple novel zinc air fuel cell constructed with graphite, water, sodium chloride, and zinc could produce greater than 129 watt-hours/kg of zinc over 90 days. The proposed chemistry is: 3Zn₍ₛ₎+3/2O_{2(g)}+3H₂O+6NaCl₍ₛ₎→Zn(OH)₃Cl²⁻+Zn(OH)₂Cl₂²⁻+ZnOHCl₃²⁻+6Na⁺. [4] Further investigations during 320 days of continuous operation has demonstrated that this zinc air fuel cell produces electricity with a specific energy of 193 watt-hours/kg zinc at an average pH of 7.7, and the cell only required for maintenance periodic addition of salt water. At the time of this writing, this fuel cell is still producing electricity. The electrodes in this zinc air fuel cell do not accumulate zinc oxide, hydrogen, dendritic zinc, or carbonates during the slow oxidation of zinc, and it produces electricity without the unpredictability of wind, sunshine, or rainfall. The cell is very simple to construct, and it could be made locally so that homes and businesses would have a reliable source of energy off the main electrical grid, which would be especially beneficial if there was a mass interruption of power supplies, such as from large solar storms or electromagnetic pulses. Whether the zinc hydroxychloride salts and sodium chloride can be separated and the zinc hydrochloride salts combusted by solar concentration to recycle zinc is not known, but if this is possible, slow oxidation of zinc in saline could be a renewable, simple, continuous, inexpensive, and environmentally friendly energy source.

### Health Insecurity

Health insecurity affects the trajectory of human civilization through extracting large financial resources for expensive poor outcome technologies and caring for an increasingly aging, chronically ill population. Common chronic illness

burdens include: arteriosclerosis (cardiac, cerebral, vascular), cancer, mental illness (depression, anxiety disorders, and psychotic disorders), chronic neurologic diseases, and chronic pain. Some proposed improved treatments for these conditions have been suggested.[5-15]

### Conflict Negotiations

A. Reconciliation of the Past during Negotiations for Conflict Resolution Negotiations need to focus on the present and future, and attempts to reconcile the past are fraught with many problems. These include:
1. Perceptions of right and wrong differ among parties because of cultural differences.
2. Perceptions of right and wrong differ because special relativity teaches that individuals in different reference frames interpret events differently.[16]
3. The past is immutable; what has happened cannot be reversed.

4. Reconciliation of the past among parties is often not achieved by negotiations. Reconciliation takes place in the mind and may not be achieved by political, social, or economic solutions. It may take generations for populations to reconcile their differences.

B. Surrogate Parties during Negotiation for Conflict Resolution

When negotiations involve more than two parties, the dynamics become much more complicated. These can be demonstrated by important negotiations in history.

At the conclusion of World War II, Joseph Stalin, Franklin Roosevelt, and Winston Churchill sought to produce a peaceful solution to war torn Europe at the Yalta summit.[17] Part of this resolution was the status of Poland. From the Russian point of view, Poland was strategically geographic for protection from future invasions. Churchill and Roosevelt saw the need for an independent Poland wherein the people determined its future. There were two major problems related to Poland that were not part of the resolution.
1. Poland was not represented at the Yalta talks.
2. Stalin may have perceived a breach of trust between his relationships with Churchill and Roosevelt, because he knew there was a secret agreement which was formalized at their 1943 Quebec meeting to cooperate on the development of an atomic bond.[17]

During the Camp David Peace Accord in 1978, the negotiations between Israel and Egypt, carried out by Anwar Sadat, Menachem Begin, and Jimmy Carter, tried to resolve the Palestinian issue.[18] However, the Palestinians were not present for the negotiations at Camp David.

The United Nations negotiations and the eventual partition of Palestine in 1948, without self-determination of the two major parties, Palestinians and Israelis, has been a continual source of political, cultural, and economic instability with many lives lost or disabled.

If the Peace of Westphalia is to be honored that sovereign nations exist, then any negotiation that influences the constituents of established and potential sovereign nations, no matter how small the populace of a nation, must include all the sovereign nations, and third party surrogates may confuse the outcome and may be illegitimate. For example: The Northern Ireland Peace Accord as mediated by former Senator George. J. Mitchell involved thirteen parties.[19] Each party was represented in negotiations, and it was an immense triumph for the negotiation process.

C. Other Reasons for Failed Conflict Resolution

There are many other well-described reasons for failure of negotiations to resolve conflicts, some of which are listed below, and the reader is referred to discussions on these topics.
1. Private information and misrepresentation of information[20]
2. Commitment problems to other parties[20]
3. Issues that cannot be divided[20]
4. Lack of creativity[21]
5. Lack of trust and biases[21]
6. Unable to separate the people from the problem[22]
7. Communications difficulties[22]
8. Failure to understand the best alternative to a negotiated agreement[22]War and Conflict Resolution

At the present time, negotiations or war are the main options to resolve international conflict. Although the causes of war are numerous, no matter how well planned, war has significant risks, and the cost of war often exceeds the benefits.[23] With certain assumptions, a rationalist approach to the benefits of war are less than what can be obtained within the bargaining range of negotiations to resolve the conflict. [20] The two most important factors to determine if war is chosen for the resolution of conflict are the failure of deterrence and the motivation of belligerent parties.[24]

### Game Theory and Conflict Resolution

Game theory as a model of conflict between two parties has four expected outcomes. They are lose-lose, win-win, lose- win, win-lose. If more than two parties are simultaneously negotiating, the same principles apply, but there are more combinations. This invention extends the present concepts in game theory applied to conflict resolution to include the (lose-lose)-win resolution of conflict.

### DESCRIPTION OF THE DRAWINGS

None

### DETAILED DESCRIPTION OF THE INVENTION

Game theory as a model of conflict between two parties has four expected outcomes, lose-lose, win-win, lose-win, win-lose. The following example will make this concept clearer: (Table 1)

Two chefs need one lemon to complete a cake recipe, but there is only one lemon available. The choices for resolving this conflict include:
1. One chef gets the lemon and the other gets no lemon [(win-lose)-competitive)]or [(lose-win)-competitive)]
2. One chef gets ½ lemon and the other gets ½ lemon [(lose-lose)-compromise)]
3. One chef needs the zest of the lemon for his recipe and the other needs the juice so each gets what he needs [(win-win)-cooperative)]

TABLE 1
Outcome for Chef's Dilemma with Creativity

Chef A

| | | |
|---|---|---|
| Chef B | ½ (zest + juice), | 0 (zest + juice), |
| | ½ (zest + juice) | 1 (zest + juice) |
| | (lose-lose) | (lose-win) |
| | ½ cake + ½ cake | 1 cake |
| | 1 (zest + juice), | 1 zest, 1 juice |
| | 0 (zest + juice) | (win-win) |
| | (win-lose) | 2 cakes |
| | 1 cake | |

In 1950, John Forbes Nash, Jr. described the equilibrium in game theory such that the choices between the parties is finalized when either party cannot improve its outcome given the other player's choices. No party can benefit from a unilateral change. The Nash equilibrium does not predict the win-win or optimum outcome, but it does predict the best final choice for parties. Another outcome of game theory is the Pareto optimal outcome, which is the most efficient outcome for both parties. Neither the Nash equilibrium nor the Pareto optimal outcome may be present or attainable in negotiations. The Pareto optimal outcome may not be achieved because parties want more for themselves without the concern of loss for others.

In the above example, the win-win, the Nash equilibrium, and the Pareto optimum are the same, but in order to attain this resolution, creativity requires that recognizing each party's needs for the lemon is different.

If such creativity is not recognized then the most likely outcome is lose-lose, that is each party gets ½ lemon and can only bake ½ of a cake. (Table 2) This example is without a Nash equilibrium, and the Pareto optimal outcome is the lose-lose outcome.

TABLE 2
Outcome for Chef's Dilemma with no Creativity

Chef A

| | | |
|---|---|---|
| Chef B | ½ (zest + juice), | 0 (zest + juice), |
| | ½ (zest& + juice) | 1 (zest + juice) |
| | (lose-lose) | (lose-win) |
| | ½ cake + ½ cake | 1 cake |
| | 1 (zest + juice), | 0 zest, 0 juice |
| | 0 (zest + juice) | (no resolution) |
| | (win-lose) | 0 cake |
| | 1 cake | |

However, to change this outcome, a third party whose interests supersedes that of both parties can be introduced such that the lose-lose outcome becomes a (lose-lose)-win. If two ½ cakes are baked, the consumer has choices (win for the consumer) and perhaps both ½ cakes will be more easily sold (win to the chefs), because a whole cake is too many calories for one buyer. This is a (lose-lose)-win outcome. (Table 3)

TABLE 3
Outcome of Chef's Dilemma with (lose-lose)-win

Chef A

| | | |
|---|---|---|
| Chef B | ½ (zest + juice), | 0 (zest + juice), |
| | ½ (zest + juice) | 1 (zest + juice) |
| | (lose-lose)-win | (lose-win) |
| | ½ cake + ½ cake All sold | 1 cake |
| | 1 (zest + juice), | 0 zest, 0 juice |
| | 0 (zest juice) | (no resolution) |
| | (win-lose) | 0 cake |
| | 1 cake | |

In resolving international conflict, win-win resolutions may not be possible, regardless of how much work is put into the process. Even with the recent advances in artificial intelligence, win-win may not be possible because game theory does not assume that such outcomes are always possible. In such cases, compromise is often the solution. Compromise by itself is often not satisfactory because both side lose something. On the other hand, compromise with a third party win is different than compromise without a third party win. The third party win needs to benefit the society outside the two parties in conflict and the general good. The third party could be other nations, the continent, and the world, but in general must supersede the interest of the two parties in conflict.

Game theory predicts that negotiations are the best rational outcome of conflict compared to war. If a win-win resolution is not possible then a (lose-lose)-win resolution may the next best outcome. In rational negotiations, the cost of war is greater than what could be settled in negotiations because the bargaining range predicts such.[20] This model assumes that bargaining involves some attribute that is divisible or that other attributes can make the non-divisible entity somewhat divisible, and that private information and commitment problems do not influence the decisions.[20]

The other assumption is leaders behave rationally (a big assumption), because emotions, beliefs, and politics bias their thinking. Also leaders are usually not at physical risk when they decide to use war as a means to resolve conflict. Regardless of what has been written in the literature related to war, in the final analysis, war is a decision that rests in the minds of leaders and their constituents, but the existence of separate sovereign states does not make war inevitable.

### Benefits to Society

In the future, hyperscanning, a technology that can monitor social interaction of brain activity for cooperative decision- making, may aid in conflict resolution.[25] However, at the present time, and until science better understands the human mind, negotiations are our best choice for conflict resolution. If the win-win outcome is not possible, the (lose-lose)-win result may be the best alternative resolution. Unfortunately game theory outcome may not accurately predict long term outcome.

### REFERENCES

1. Goldberg, J. S., PROCESSING OF PERENNIAL RYE GRASS (LOLIUM PERENNE) FOR HUMAN CONSUMPTION US 2019/0281864 A1, 2019, USPTO.
2. Goldberg, J. S., DECALCIFICATION OF PASTURE GRASS FOR FOOD AND FUEL US 2016/0270425 A1, 2016, USPTO.
3. Southey, F. Could grass protein be the next new plant based food ingredient. 2019.
4. Goldberg, J. S., NOVEL ZINC AIR FUEL CELL WITH LONGEVITY US 2019/0296409 A1, 2019, USPTO.
5. Goldberg, J. S., Atherosclerosis: Viewing the Problem from a Different Perspective Including Possible Treatment Options. Lipid Insights, 2011. 4: p. 17-26.
6. Goldberg, J. S., METHOD TO DECREASE BRAIN INJURY FOLLOWING CEREBRAL ISCHEMIA US 2016/0228664 A1, 2016, USPTO.
7. Goldberg, J. S., INHIBITION OF GLYCOLYSIS WITH 2-DEOXY-D-GLUCOSE AND D-LACTIC ACID DIMER-Projected publication Sep. 3, 2020, 2020, USPTO.
8. Goldberg, J. S., C. E. Bell, Jr., and D. A. Pollard, Revisiting the monoamine hypothesis of depression: a new perspective. Perspect Medicin Chem, 2014. 6: p. 1-8.
9. Goldberg, J. S., CITRATE DISSOLUTION OF BETA-2-MICROGLOBULIN AND AMYLOID BETA PEPTIDE (1-40) AGGREGATES US 2018/0333379 A1, 2018, USPTO.
10. Goldberg, J. S., TREATMENT OF AMYOTROPHIC LATERAL SCLEROSIS WITH LACTATE US 2016/0271085 A1, 2016, USPTO.
11. Goldberg, J. S., CITRATE RESORPTION OF BONE AS A TREATMENT FOR SPINAL STENOSIS U.S. Pat. No. 9,616,040 B2, 2017, USPTO.
12. Goldberg, J. S., Monitoring maternal Beta carotene and retinol consumption may decrease the incidence of neurodevelopmental disorders in offspring. Clin Med Insights Reprod Health, 2011. 6: p. 1-8.
13. Goldberg, J. S., Chronic opioid therapy and opioid tolerance: a new hypothesis. Pain Res Treat, 2013: p. 407-504.
14. Goldberg, J. S., TRANSMAGENTIC LESIONING OF THE NERVOUS SYSTEM FOR RELIEF OF INTRACTABLE PAIN US 2017/0189709 A1, 2017, USPTO.
15. Goldberg, J. S., PDLA a potential new potent topical analgesic: a case report. Local Reg Anesth, 2014. 7: p. 59-61.
16. Goldberg, J. S., REGULATION OF THALAMIC/ACTIVITY FOR CONTROL OF AGGRESSION US 2019/0030335 A1, 2019, USPTO.
17. Preston, D., Eight Days at Yalta How Churchill, Roosevelt and Stalin Shaped the Post-War World. 2019, New York, N.Y.: Atlantic Monthly Press.
18. Wright, L., Thirteen Days in September. 2015, New York, N.Y.: Vintage Books.
19. Mitchell, G. J., Making Peace. 1999, New York, N.Y.: Alfred A. Knopf Inc.
20. Fearon, J. D., Rationalist explanations for war. International Organization, 1995. 49.
21. Peter T. Coleman, M. D., Eric C. Marcus, The Handbook of Conflict Resolution Theory and Practice Third Edition. 2014, San Francisco, Calif.: Jossey-Bass.
22. Roger Fisher, W. U., Bruce Patton, Getting to Yes Negotiating Agreement Without Giving In. 2011, New York, N.Y.: Penguin Books.
23. Jack S. Levy, W. R. T., Causes of War. 2010, United Kingdom: John Wiley & Sons, Ltd.
24. Michael J. Mazarr, A. C., Alyssa Demus, Bryan Frederick, Alireza Nader, Stephanie Pezard, Julia A. Thompson, Elina Treyger, What Deters and Why Exploring Requirements for Effective Deterrence of Interstate Agrgression. 2018, Santa Monica, Calif.: RAND Corporation.
25. Goldberg, J. S., Jackson, C. L., METHOD TO IMPROVE OUTCOMES DURING NEGOTIATIONS US 2020/0108264 A1, 2020, USPTO.

Having described my invention, I claim:

1. A method to improve negotiation between two parties where the interests of an additional third party produces a (lose-lose)-win outcome.

2. The method of claim 1, where the interests of the additional third party supersedes the interests of the said two parties.
